(19) United States
(12) Patent Application Publication
(10) Pub. No.: US 2008/0160227 A1
(43) Pub. Date: Jul. 3, 2008

(54) Method for forming an item having desirable energy absorption properties and an item formed by the method

(76) Inventor: Joseph S. Wycech, Gross Pointe Shores, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/327,607

(22) Filed: Jan. 6, 2006

(51) Int. Cl. B32B 5/16; B60R 13/00; B05D 1/12; B32B 18/00

(52) U.S. Cl. 428/31; 428/323; 428/325; 428/327; 427/180

(57) ABSTRACT

An item, such as a vehicle headliner 10, which has programmably enhanced energy absorption characteristics and at least one methodology 100 for forming such an item. Particularly, the programmable energy absorption enhancement is created, in one non-limiting embodiment, by the use of glass filled and coated bead members, such as members 14-22 which are selectively deployed upon the pre-item, such as a vehicle headliner 10.

### GENERAL BACKGROUND

1. Field of the Invention

The present invention generally relates to a method for forming an item having desirable energy absorption properties and to an item which is formed by the method and more particularly by way of example and without limitation, to a vehicle component, such as a headliner, which is formed in a manner which allows the vehicular headliner to have very desirable and programmable energy absorption features and characteristics.

2. Background of the Invention

Oftentimes it is desirable to selectively form or create an item or component which readily and efficiently absorbs energy. For example and without limitation, such an item may be used within a vehicle or other selectively movable assembly and be positioned and adapted to selectively absorb “impact type energy” associated with the impact made to the item or component by an occupant of the vehicle or other selectively movable assembly (e.g., such as during a “crash” type event). Such energy absorption has been found to protect the occupants and reduce the likelihood of injury during a collision.

Thus, it is very desirable to provide an item or component which absorbs a relatively large amount of energy in a cost effective manner, since there is a direct correlation between the protection provided by such an item or component and the amount of energy which is absorbed by the provided item or component (e.g., the more energy which is absorbed by the item, the more protection which is provided). Such energy absorption items and components are also often used to protect other fragile type components (e.g., electronic type assemblies).

Many current strategies do not provide enough energy absorption in a cost effective manner and do not provide varying and programmable levels of energy absorption, thereby tailoring the respectively provided amount of energy absorption to various spatial areas or locations where it is needed. Hence, these prior strategies typically provide a fixed amount of energy absorption and thus this fixed and unchanging and “non-programmable” amount of energy absorption is either “not enough” in certain locations or is more than what is needed in other locations, providing and representing both a costly (i.e., the cost associated with the amount of energy absorption that exceeds the amount that is needed is wasted) and technically deficient (i.e., the lack of energy absorption provides an undesirably deficient situation) solution.

There therefore exists a need for a new and improved energy absorption strategy and technique which allows for the selective creation of an item having desired energy absorption properties but which may be produced in a cost effective manner and for a strategy and technique which allows an item to be produced having programmable energy absorption characteristics and features (e.g., the provided energy absorption characteristic may be intentionally varied and different at various locations of the produced item). The present invention provides for these and other features and advantages in a new and novel fashion.

### SUMMARY OF THE INVENTION

It is a first non-limiting advantage of the present inventions to provide a method for making a member or item having desirable energy absorption characteristics.

It is a second non-limiting advantage of the present inventions to provide an item or component having desired energy absorption properties/characteristics.

It is a third non-limiting advantage of the present inventions to provide an item or component having programmable energy absorption characteristics.

It is a fourth non-limiting advantage of the present inventions to provide a vehicular component having programmable energy absorption characteristics.

It is a fifth non-limiting advantage of the present inventions to provide a method for cost effectively making a vehicular component having enhanced energy absorption characteristics.

According to a first non-limiting aspect of the present invention, a method for forming an item is provided and includes the steps of forming a pre-item; placing a tool upon the pre-item; obtaining a plurality of bound beads; placing at least some of the plurality of bound beads within the tool; curing the bound beads upon the pre-item; and removing the tool, thereby forming the item.

According to a second non-limiting aspect of the present invention, a method for forming a vehicle headliner assembly is provided and includes the steps of obtaining a headliner member; and placing a plurality of bound beads upon the headliner member in a predetermined pattern, thereby forming the headliner assembly.

According to a third non-limiting aspect of the present invention, a method for creating a vehicle headliner assembly is provided and includes the steps of forming an object comprised of a plurality of bound beads; and casting the object onto the headliner assembly.

According to a fourth non-limiting aspect of the present invention, a vehicle component is provided and includes a body portion; and a plurality of bound and/or coated beads which are absorbably disposed upon the body portion.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a top view of an item made in accordance with the teachings of the preferred embodiment of the invention.

FIG. 2 is a top view of an item made in accordance with the teachings of a first alternate embodiment of the invention.

FIG. 3 is a top view of an item made in accordance with the teachings of a second alternate embodiment of the invention.

FIG. 4 is a top view of an item made in accordance with the teachings of a third alternate embodiment of the invention.

FIG. 5 is a top view of an item made in accordance with the teachings of a fourth alternate embodiment of the invention.

FIG. 6 is a flow chart illustrating and comprising the item/component formation methodology of the preferred embodiment of the invention.

FIG. 7 is a top view of an item being formed according to the methodology of the preferred embodiment of the invention.

FIG. 8 is a top view of a tool which is shown in FIG. 7 and which is used by the item/component formation methodology of the preferred embodiment of the invention.

FIG. 9 is a flow chart illustrating and comprising the item/component formation methodology of a second and alternate embodiment of the invention.

FIG. 10 is an exploded side view of selectively created energy absorption members which are used according to the various techniques and strategies of the various delineated inventions.

FIG. 11 is a top view of an item which is made in accordance with the teachings of a fifth alternate embodiment of the invention.

### DETAILED DESCRIPTION OF THE PREFERRED EMBODIMENT OF THE INVENTION

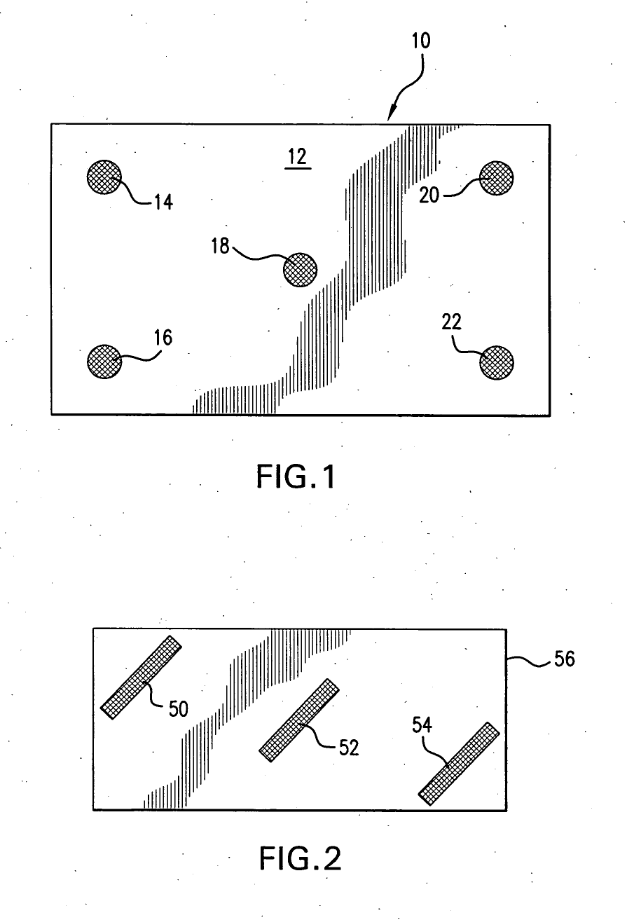

Referring now to FIG. 1, there is shown an item or component 10 which is made in accordance with the teachings of the preferred, although non-limiting embodiment of the invention.

It should be appreciated that in the foregoing discussion, the terms “component” and “item” are interchangeably utilized to refer to substantially any tangible item or “thing” which utilizes or is made in accordance with the energy absorption strategies and principles of the various inventions which are delineated in this description. Thus, the terms “component” or “item” should not be constrained to only refer to a particular type or class of tangible items, such a tangible item which is operatively disposed within a vehicle. Rather, these terms should be broadly construed to refer to substantially any desired tangible item or thing. For example and without limitation, the tangible item 10 may comprise a vehicle headliner. Further, these components and items may be selectively placed in any selectively movable assemblies and used in substantially any type of energy absorption application.

As is further shown in FIG. 1, upon the surface 12, which may comprise the top surface of the item 10 (e.g., the surface of the headliner which is disposed within the vehicular passenger compartment), are disposed energy absorption members 14, 16, 18, 20, 22 which cooperatively form a certain predefined pattern. One non-limiting example of such a pattern requires the placement of an energy absorption member at each corner and in the center of item 10, although other patterns may be created and utilized.

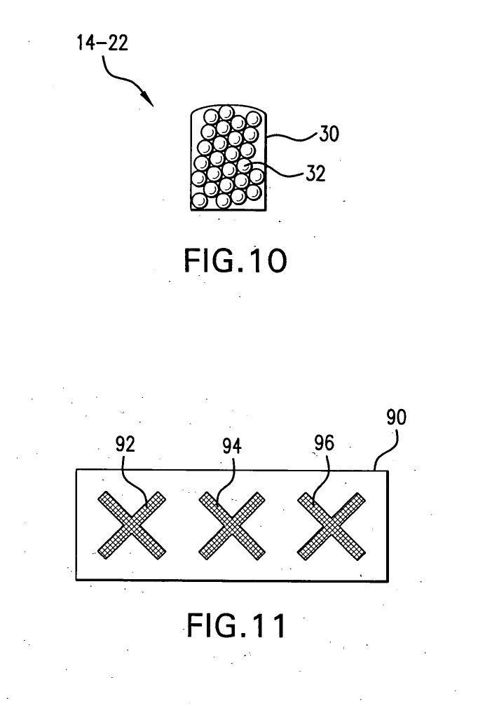

As shown best in FIGS. 1 and 10, each of the energy absorption members 14-22 is substantially identical and generally bulbous in shape (e.g., formed in the general shape of a cupcake). Particularly, each of the members 14-22 includes a generally elongated or outer coating portion 30 which substantially encapsulates a plurality of substantially identical glass type and adhesively bound beads 32. Impact energy which is imparted to a member 14-22 initially causes the coating 32 to expand and then, depending upon the strength of the impact type energy, causes the contained beads 32 to be destroyed (e.g., to become a dust like material). Thus the plurality of contained glass type beads are friable and the coating 30 concomitantly absorbs energy and allows the contained beads 32 to be selectively and stationarily placed in any desired location upon the item 10, thereby allowing energy absorption properties to be programmably placed upon/within the item 10. In this manner, the coating 30 and the plurality of contained beads 32 cooperatively absorb the received impact type energy, thereby protecting the occupants of the vehicle or assembly or other individuals.

In various alternate embodiments of the invention, the coating 30 may comprise epoxy, neoprene, latex, polyurethane, and/or polyurea or similar types of material. Further, as best shown in FIG. 2, energy absorption entities 50, 52, 54 may be provided upon an item 56 (which may be substantially similar to item 10) and such entities 50, 52, 54 respectively comprise coated beads and are therefore substantially similar to members 14-22 except that members or entities 50-54 are ribbed shaped.

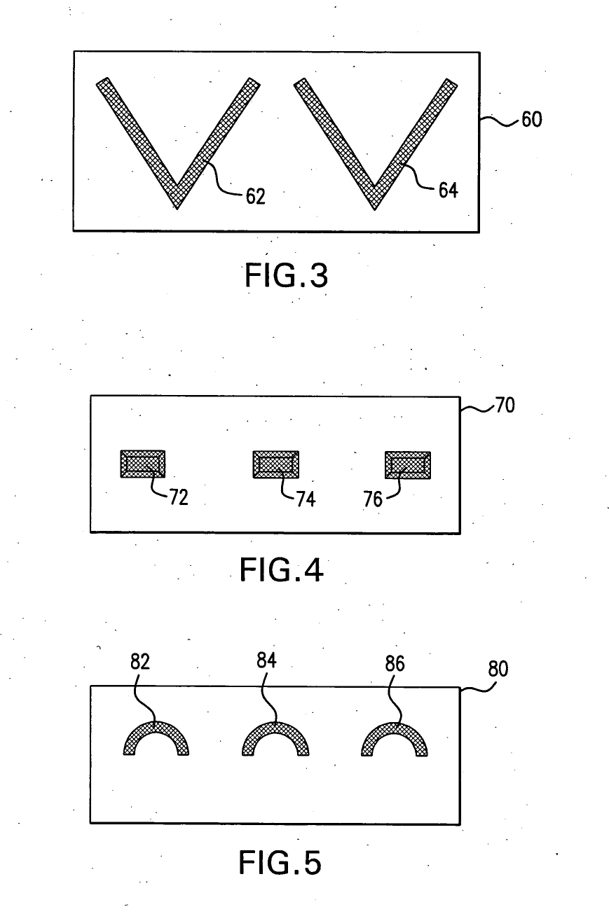

As shown best in FIG. 3, an item 60 may be formed which may be substantially similar to item 10 except that energy absorption members 62, 64 are each “V” or “sergeant” shaped. Particularly, other than being “V” shaped, the members 62, 64 are each substantially similar to members 14-22.

As shown best in FIG. 4, an item 70 may be formed which may be substantially similar to item 10 except that the energy absorption members 72, 74, and 76 are cubic or “lattice” shape (e.g., in one non-limiting embodiment having a three dimensional cubic shape). Particularly, other than being cubic or “lattice” shaped, the members 72, 74, and 76 are each substantially similar to members 14-22.

As shown best in FIG. 5, an item 80 may be formed which may be substantially similar to item 10 except that the energy absorption members 82, 84, and 86 are generally arcuate in shape. Particularly, other than being generally arcuate, the members 82, 84, and 86 are each substantially similar to the members 14-22.

As shown best in FIG. 11, an item 90 may be formed which may be substantially similar to item 10 except that the energy absorption members 92, 94, and 96 are generally “X” shaped. It should be appreciated that members 92, 94, 96 may be shaped in any desired alphabetical shape (e.g. a shape corresponding to any letter in the English, Arabic, or any other known alphabets). It should be further appreciated that the foregoing described energy absorption members, may be placed upon a respective tangible item in substantially any desired pattern or location, thereby allowing the produced items, such as tangible items 10, 56, 60, 70, 80, and 90 to be programmed to have enhanced or desired energy absorption characteristics at the exact location(s) where such enhanced or desired characteristics are needed and to obviate the need to provide such enhanced characteristics where they are not needed, thereby allowing such an enhanced energy absorption member or item or component, such as a vehicle headliner 10, to be cost effectively produced and manufactured.

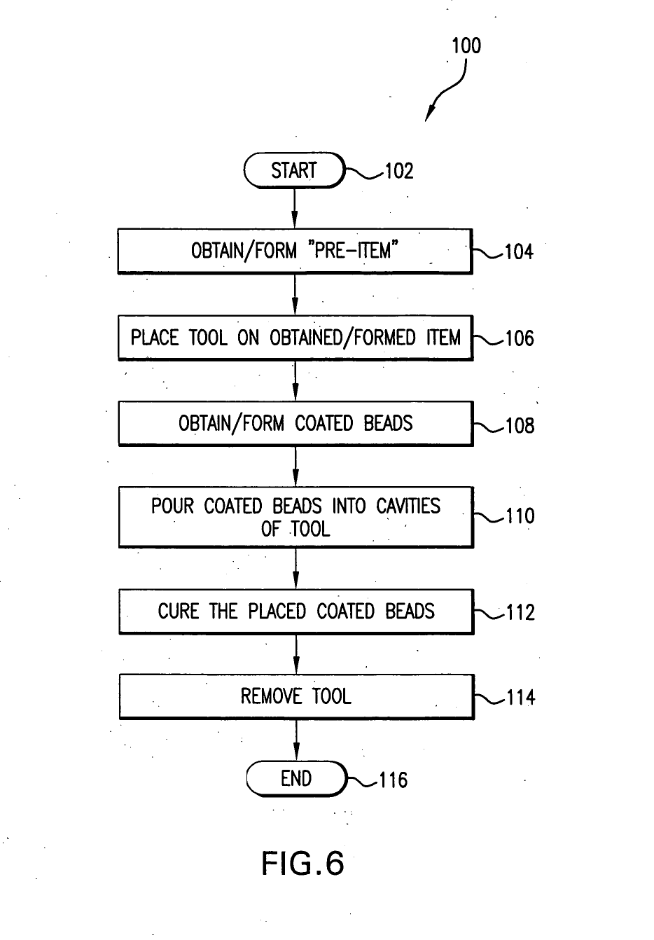

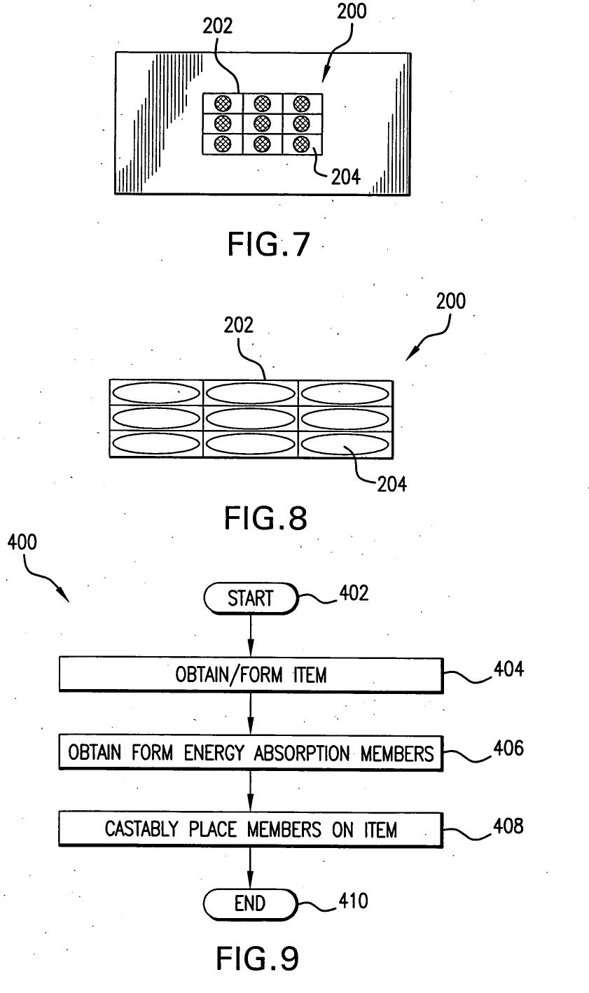

To understand the methodology and strategy of one non-limiting technique of the present inventions, reference is now made to FIG. 6 where there is shown a flowchart 100 which comprises such a methodology and strategy.

Particularly, the flowchart or methodology/strategy 100 begins with an initial step 102 in which a user determines that an enhanced energy absorption item/component is needed. Step 104 follows step 102 and, in this step 104, a “pre-item” is formed or obtained. Particularly, the term “pre-item” means or refers to an item, such as a vehicle headliner, which does not have the programmably enhanced energy absorption characteristics which form a portion of the present invention but which may be used in a conventional but “non-energy enhanced” manner. Step 104 is followed by step 106 in which a certain tool is obtained and is operatively placed upon the formed item (e.g., upon a predetermined location of surface 12 of the headliner 10).

One non-limiting example of such a tool is represented by tool 200 of FIG. 8. Particularly, the tool 200 includes a generally rectangularly shaped body portion 202 and at least one “through type hole” or cavity 204 which has a certain shape or overall spatial or geometric orientation which is substantially similar in shape and size (e.g., in overall geometric or spatial orientation) to the shape, size, and overall geometric/spatial orientation of the desired energy absorption member, such as member 20, which is to be created. Thus, various tools may be utilized depending upon the size, shape, and overall spatial and geometric orientation of the energy absorption member which is to be formed.

Step 108 follows step 106 and, in this step 108, coated beads are obtained. The obtained coated beads may correspond to and be substantially similar to the coated beads 32. Step 110 follows step 108 and, in this step 110, the obtained coated beads are poured or otherwise placed into the at least one cavity, such as cavity 204, of the obtained/formed tool, such as tool 200.

Step 112 follows step 110 and, in this step 112, the placed coated beads are cured within the tool. Such curing may be accomplished by the use of heat and is effective to stationarily or fixedly place the coated beads upon the portion of the item such as surface 12 of item 10, that they resided upon when they were placed in the tool 200. Step 114 follows step 112 and, in this step 114, the tool, such as tool 200, is removed from the item/component such as head liner 10, thereby leaving the placed and formed coated beads upon the item/component, such as head liner 10, and the general location in which the tool was placed. Step 116 follows step 114 and denotes the end of the methodology 100. In an alternate embodiment, the cured and placed selectively bound beads may be selectively coated with a material, such as neoprene material, polyurethane material, polyurea material or a liquid rubber material after step 114 but before step 116.

Referring now to FIG. 9, there is shown an alternate methodology 400 of the present invention. Particularly, the methodology 400 begins with an initial step 402 in which a user of the methodology determines that an enhanced energy absorption item/component should be selectively created.

Step 404 follows step 402 and, in this step 404, the desired pre-item is obtained and/or selectively formed (e.g., such as a vehicle headliner 10). Step 406 follows step 404 and, in this step 406, energy absorption members, such as members 14-22 are created. Step 408 follows step 406 and, in this step 408, the formed/created energy absorption members, such as members 14-22, are castably placed at a certain location on the obtained/formed pre-item such as headliner 10. Such casting causes the coated beads to stationarily remain at the location they were placed. Step 410 follows step 408 and denotes the end of the methodology 400. In an alternate embodiment, the castably placed members which respectively formed by bounded beads may be sprayed with neoprene, and/or polyurethane, and/or liquid rubber or another material only after step 408 but before step 410. In yet another non-limiting embodiment, the entire item may be coated with polyurea, polyurethane, or another such material after the members (e.g., bound beads which may or may not be initially coated) are disposed on the item in a manner that is delineated above. Thus, it should be clear, that in one embodiment the selectively positioned or placed beads may be selectively coated and in another non-limiting embodiment the entire created item may be selectively coated after the beads (which may or may not be initially coated) are placed upon the item.

It is to be understood that the inventions are not limited to the exact construction or methodology which has been delineated above, but that various changes and modifications may be made without departing from the spirit and the scope of the inventions as are more fully delineated in the following claims. It should be further appreciated that after the energy absorption members, such as members 14-22 are placed upon surface 12 of an item or pre-item, such as headliner 10, the placed members 14-22 may be selectively covered with another member or any sort of desired covering in order to provide a more pleasing overall aesthetic appearance. It should be appreciated that the energy absorption members, such as members 14-22 may be placed on the item, such as item 10, during the manufacturing/formation process of the item. In one non-limiting embodiment, the beads may be bound by a water based latex material (e.g., commonly referred to as a R50 or R25 material) made by Raeco, Inc. of Seattle, Wash. The binder which holds the beads together could also comprise epoxy material. Further, in yet another non-limiting embodiment, the bead coating may be initially applied to and within the cavities 204 of the tool 200 before the bound beads are deposited within these cavities 204. It should be appreciated that the beads could be made from ceramic material or could be spherical or evacuated.

What is claimed is:

1) A method for forming an item comprising the steps of forming a pre-item; placing a tool upon the pre-item; obtaining a plurality of bound beads; placing at least some of the plurality of bound beads within the tool; curing the coated beads upon the pre-item; and removing the tool, thereby forming said item.

2) The method of claim 1 wherein said method further comprises the step of coating said beads with epoxy.

3) The method of claim 1 wherein said method further comprises the step of coating said beads with neoprene.

4) The method of claim 1 wherein said method further comprises the step of coating said beads are coated with latex.

5) The method of claim 1 wherein said method further comprises the step of coating said beads with polyurethane.

6) The method of claim 1 wherein said method further comprises the step of coating said beads with liquid rubber.

7) A method for forming a vehicle headliner assembly comprising the steps of obtaining a headliner member; and placing a plurality of bound beads upon a surface of said headliner member in a predetermined pattern, thereby forming said headliner assembly.

8) The method of claim 7 further comprising the step of coating said bound beads with a certain material.

9) The method of claim 7 further comprising the step of coating said bound beads and said surface of said headliner with a certain material.

10) The method of claim 8 wherein said predetermined pattern comprises at least one cupcake shaped deposit of coated beads.

11) The method of claim 8 wherein said predetermined pattern comprises a ribbed pattern.

12) The method of claim 8 wherein said predetermined pattern comprises a V-shaped pattern.

13) The method of claim 8 wherein said predetermined pattern comprises a cubic pattern.

14) The method of claim 8 wherein said predetermined pattern comprises an arcuate pattern.

15) The method of claim 8 wherein said predetermined pattern comprises an X-shaped pattern.

16) The method of claim 8 wherein said predetermined pattern comprises an alphabetical shaped pattern.

17) A method for creating a vehicle headliner assembly comprising the steps of forming an object comprised of a plurality of coated beads; and casting said object onto said headliner assembly.

18) The method of claim 17 wherein said beads comprise glass beads and wherein said glass beads are coated with epoxy.

19) The method of claim 17 wherein said beads comprise glass beads and wherein said glass beads are coated with neoprene.

20) The method of claim 17 wherein said beads comprise glass beads and wherein said glass beads are coated with latex.

21) The method of claim 17 wherein said beads comprise glass beads and wherein said glass beads are coated with polyurethane.

22) A vehicle component comprising a body portion; and a plurality of coated beads which are absorbably disposed upon said body portion.

23) The vehicle component of claim 22 wherein said vehicle component comprises a vehicle headliner and wherein said plurality of coated beads are disposed upon said headliner in a predetermined pattern.

24) The vehicle component of claim 23 wherein said plurality of coated beads comprise glass beads which are coated with epoxy.

25) The vehicle component of claim 23 wherein said plurality of coated beads comprise glass beads which are coated with neoprene.

26) The vehicle component of claim 23 wherein said plurality of coated beads comprise glass beads which are coated with latex.

27) The vehicle component of claim 23 wherein said plurality of coated beads comprise glass beads which are coated with polyurethane.

28) The vehicle component of claim 23 wherein said predetermined pattern comprises a ribbed pattern.

29) The vehicle component of claim 23 wherein said predetermined pattern comprises an arcuate pattern.

30) The vehicle component of claim 23 wherein said predetermined pattern comprises a cupcake shaped pattern.

31) The vehicle component of claim 23 wherein said predetermined pattern comprises a cubic pattern.

32) The vehicle component of claim 23 wherein said predetermined pattern comprises an alphabetical pattern.
